(19) United States
(12) Patent Application Publication
(10) Pub. No.: US 2006/0158699 A1
(43) Pub. Date: Jul. 20, 2006

(54) Image forming apparatus and a method of copying a document having irregular page

(76) Inventor: Seung-soo Lee, Suwon-si (KR)

Correspondence Address: STANZIONE & KIM, LLP, 919 18TH STREET, N.W., SUITE 440, WASHINGTON, DC, 20006, US

(21) Appl. No.: 11/326,450

(22) Filed: Jan. 6, 2006

(30) Foreign Application Priority Data
Jan. 14, 2005 (KR) 2005-3567

(51) Int. Cl. H04N 1/04

(52) U.S. Cl. 358/474

(57) ABSTRACT

An image forming apparatus and a controlling method thereof. The controlling method includes reading at least one irregular document on a flat board unit, reading a regular document supplied by an automatic document feeder (ADF), storing image data read from the at least one irregular document and the regular document, generating collate stored image data by inserting the stored image data from the at least one irregular document into the stored image data from the regular document according to a predetermined order; and printing the collate stored image data.

### CROSS-REFERENCE TO RELATED APPLICATIONS

This application claims the benefit under 35 U.S.C. § 119(a) from Korean Patent Application No. 2005-3567, filed on Jan. 14, 2005 in the Korean Intellectual Property Office, the entire contents of which are incorporated herein by reference.

### BACKGROUND OF THE INVENTION

1. Field of the Invention

The present general inventive concept relates to an image forming apparatus and a controlling method thereof. More particularly, the present general inventive concept relates to an image forming apparatus to copy a document in which irregular pages are randomly included, and a method thereof.

2. Description of the Related Art

General image forming apparatuses, such as a copy machine and a multi-function office machine, are equipped with a ‘collation copy’ function in which image data of all pages of a document stacked on an automatic document feeder (ADF) are read as a set by scanning, and the set of read image data is printed a number of times corresponding to the required number of copies. For example, when a user stacks a document comprising 5 pages on the ADF and selects the collation copy function with the number of copies set to 2, pages 1 to 5 of the document are printed twice.

Conventionally, however, when the document comprises an irregular page, such as a photo or a card, which cannot be fed through a general ADF, as illustrated in FIG. 1, a copy of the document cannot be performed by simply stacking the whole document on the ADF. In order to solve this problem, the following two methods have been used traditionally. In FIG. 1, pages 1, 2, 3 and 5 have a regular size and may be fed through the general ADF for scanning and printing afterward. However, page 4 has an irregular size and can not be fed through the ADF. Page 4 may be a photo, a business card, a plastic card or embossed materials.

In the first method, the regular pages 1, 2, 3 and 5 are copied through the ADF a number of times corresponding to the number of copies set for the collation copy function. The irregular page 4 is placed on a platen glass and copied separately to yield the same number of copies. Then, a user inserts manually the irregular page 4 one by one between the regular pages in the right order, for example, between the page 3 and the page 5 of each set.

In the second method, the irregular page 4 is copied while placed on the platen glass, to generate a copy of page 4 having the regular size. The copy of page 4 now having the regular size is inserted in the original document according to the page order, between the page 3 and the page 5. The ordered pages are stacked on the ADF and copied together according to the collation copy function.

However, according to the first method, especially when the number of copies is large, it is very cumbersome for the user to manually insert the irregular pages which are separately copied between the regular pages according to the right order.

Also, according to the second method, by recopying a once-copied document the image quality deteriorates. Further, when the document includes one or more irregular pages, the user has to put the irregular pages on the platen glass and copy the irregular pages one by one. Then, the user has to insert the separately copied pages between the regular pages according to the right order and then to stack the whole document on the ADF. The second method is also a very inefficient method.

### SUMMARY OF THE INVENTION

The present general inventive concept provides an image forming apparatus to copy a document including irregular pages without separately copying and inserting into regular pages the irregular pages or recopying the irregular pages, and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a method of controlling an image forming apparatus having an automatic document feeder (ADF) and a flat board unit for collation copy, the method comprising reading at least one first document on the flat board unit, reading a second document supplied by the ADF, storing image data read from documents the at least one first document and the second document, arranging the stored image data according to a predetermined order, and printing the arranged image data according to the predetermined order.

The method may further comprise displaying the image data according to the predetermined order, and changing the predetermined order to generate a new order so that pages of the image data can be arranged according to the new order.

The method may further comprise inputting the number of copies, and printing of the image data according to the predetermined order and the input number of copies.

The at least one first document may comprise at least one irregular document, the second document may comprise a regular document, and the reading of the at least one irregular document on the flat board unit, may comprise inputting a page number of the at least one irregular document, and reading the image data by scanning the at least one irregular document input with the page number on the flat board unit.

The method may further comprise checking whether there is additional irregular document to be scanned, and inputting another page number for the additional irregular document and reading the image data of the additional irregular document.

The method further comprises inputting the number of times corresponding to the at least one irregular document; and repeating the inputting of the page numbers of the irregular document and the reading of the image data of the irregular document according to the input number of times.

The reading the second document supplied from the ADF may comprise reading the image data by scanning the regular document supplied by the ADF, and allocating second page numbers to the read image data of the regular document, without allocating the input second page number to the at least one irregular document.

The predetermined order may be an order in which the respective image data of the regular and irregular documents are received.

The storing of the image data of the at least one irregular document and the regular document may comprise storing the image data of the read regular document and the at least one irregular document with the corresponding page numbers.

The foregoing and/or other aspects of the present general inventive concept may also be achieved by providing an image forming apparatus having an automatic document feeder (ADF) and a flat board unit for collation copy, the image forming apparatus comprising a scan unit to read image data from a a first document placed on the flat board unit and a second document supplied by the ADF, a storage unit to store the image data read from the first and second documents, a control unit to arrange the stored image data in a predetermined order, and a print unit to print the arranged image data according to the predetermined order.

The image forming apparatus may further comprise a display unit to display the stored image data arranged in the predetermined order, and an input unit to input a new order so that the displayed image data is rearranged according to the new order.

The scan unit may scan the document placed on the flat board unit by moving in a conveyance direction and scans the document supplied from the ADF in a fixed position.

The second document may comprise a regular document supplied by the ADF and the first document may comprise at least one irregular document placed on the flat board unit.

The image forming apparatus may further comprise an input unit to input a first page number of the at least one irregular document and one or more second page numbers of one or more pages of the regular document. The control unit may allocate the second page numbers to the one or more regular document in an order in which the one or more pages are scanned by the scan unit, while allocating the first page number to the at least one irregular document.

The storage unit may store the image data read by the scan unit with the corresponding first and second page numbers.

The input unit may further input the number of copies, and the control unit may control the print unit to print the image data in the predetermined order a number of times corresponding to the input number of copies.

The foregoing and/or other aspects of the present general inventive concept may also be achieved by providing a method of controlling an image forming apparatus, the method including inputting a second page number, reading a second document to generate second data, storing the second data of the read second document with the second page number, inputting a first page number and a third page number, reading a first document and a third document to generate first and third data, storing the read first and third documents with the first and third page numbers, respectively, and arranging the first data, the second data, and the third data according to the first, second, and third page numbers.

The foregoing and/or other aspects of the present general inventive concept may also be achieved by providing an image forming apparatus including an input unit to input a first, a second, and a third page number, a first reading unit to read a first and a third document to generate corresponding first and third data, a second reading unit to read a second document to generate corresponding second data, a storage unit to store the first, second and third data with the first, second and third page numbers, and a control unit to arrange the first, the second and the third data according to the first the second and the third page numbers.

The foregoing and/or other aspects of the present general inventive concept may also be achieved by providing a computer readable storage medium to store computer readable codes to perform a method of controlling an image forming apparatus, the method including inputting a second page number, reading a second document to generate second data, storing the second data of the read second document with the second page number, inputting a first page number and a third page number, reading a first document and a third document to generate first and third data, storing the read first and third documents with the first and third page numbers, respectively, and arranging the first data, the second data, and the third data according to the first, second, and third page numbers.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a document which includes irregular pages that can not be fed through an automatic document feeder (ADF) in a conventional image forming apparatus;

FIG. 2 is a block diagram illustrating an image forming apparatus according to an embodiment of the present general inventive concept;

FIG. 3 is a flowchart illustrating a method of controlling the image forming apparatus according to an embodiment of the present general inventive concept; and

FIG. 4 is a flowchart illustrating operations S320 and S330 of the method of FIG. 3.

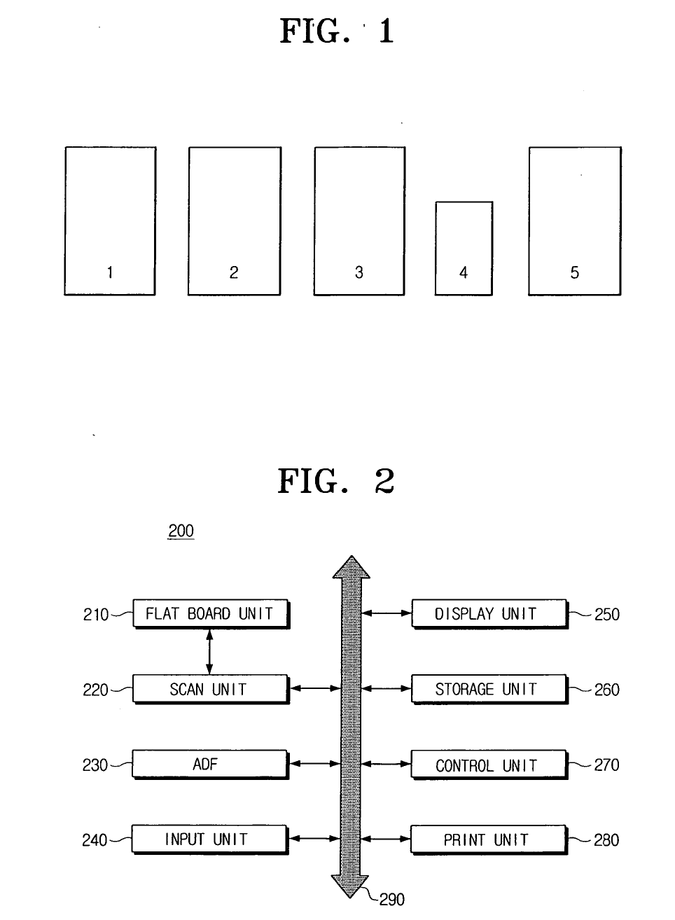

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 2 is a block diagram of an image forming apparatus according to an embodiment of the present general inventive concept.

Referring to FIG. 2, an image forming apparatus 200 comprises a flat board unit 210, a scan unit 220, an automatic document feeder (ADF) 230, an input unit 240, a display unit 250, a storage unit 260, a control unit 270 and a print unit 280. The scan unit 220, the ADF 230, the input unit 240, the display unit 250, the storage unit 260, the control unit 270 and the print unit 280 communicate with one another through a data bus 290.

The ADF 230 supplies regular documents having a predetermined size, as stacked thereon, to the scan unit 220 sheet by sheet so that image data corresponding to pages of the regular document are successively read. The regular document herein refers to a document having a page size suitable for the ADF 230, which stacks and feeds the document to read the image data. The regular document may be A4-size paper or B5-size paper.

The flat board unit 210 is a document tray to place an irregular document thereon. The flat board unit 210 may be formed of transparent platen glass or transparent plastic. The irregular documents, such as a photo, a business card, a plastic card, embossed material, etc., have sizes not suitable to be processed through the ADF 230 to the scan unit 220. Therefore, the irregular documents are placed on the flat board unit 210 so that the image data corresponding to the irregular documents are read one by one. The regular documents can be placed on the flat board unit 210 to be scanned, and the irregular documents may be scanned using the ADF 230.

The scan unit 220 scans the regular document to read the image data in an order in which the pages are supplied from the ADF 230. The scan unit 220 also scans the irregular document placed on the flat board unit 210 to thereby read the corresponding image data. The scan unit 220 comprises a scanning module (not shown) which scans the irregular document placed on the flat board unit 210 by moving in a conveyance direction of the document and scans the regular document being supplied by the ADF 230 in a fixed position.

The user may select a copy mode, such as a duplicate copy mode, a collation copy mode, a magnification copy mode and a reduction copy mode, to be performed in the image forming apparatus 200 and may set the number of copies, using the input unit 240. The input unit 240 sends the user-selected mode, the number of copies, and other user input data to the control unit 270. The input unit 240 comprises character keys, numeric keys and shortcut keys to enable the user to select functions. If the collation copy mode is selected, the user inputs through the input unit 240 information on whether the document includes any irregular document and a page number of the irregular document. When any error occurs in the order of the image data displayed through the display unit 250, the user inputs a new order using the keys of the input unit 240. The new order is transmitted to the control unit 270 to correct the error.

Under the control of the control unit 270, the display unit 250 displays menu screens to select various operations of the image forming apparatus 200 and to display operation states of the image forming apparatus 200. The display unit 250 may be a liquid crystal display (LCD) panel. The display unit 250 displays the image data arranged by the control unit 270 so that the user is able to verify whether the order is right, that is, whether the regular documents and the irregular document are arranged according to the set order.

The storage unit 260 stores controlling programs for operating the image forming apparatus 200 and various data generated during the operation of the image forming apparatus 200. More specifically, the storage unit 260 stores the image data read by the scan unit 220. In addition, the storage unit 260 stores the page number of the irregular document input through the input unit 240, and page numbers allocated to the image data read from the regular documents.

The print unit 280 prints the image data read by the scan unit 220 according to a predetermined printing condition, under the control of the control unit 270. The print unit 280 prints the image data stored in the storage unit 260 in the set order. The printing order is described in greater detail hereinafter.

The control unit 270 controls the overall operations of the image forming apparatus 200. More specifically, when the collation copy mode is selected, the control unit 270 displays a message through the display unit 250 to check whether one or more documents to be copied include any irregular document. When the documents to be copied include an irregular document, the control unit 270 displays a message inquiring the page number of the irregular document. The page number is input by the user through the input unit 240, and stored in the storage unit 260 together with the image data of the irregular document read by the scan unit 220.

The control unit 270 allocates (assigns) the page numbers to the image data of the regular documents supplied from the ADF 230 and read by the scan unit 220 while not assigning the page numbers to the irregular document, and also assigns the page number to the irregular document. Then, the control unit 270 arranges the read image data of the irregular document and the regular document according to the page numbers. The page numbers of the regular documents do not include the page number of the irregular document.

The control unit 270 transmits the image data from the storage unit 260 to the print unit 280 in the order of the page numbers and controls to repeat printing of the image data a number of times according to the number of copies. Through the above processes, the collation copy mode is performed for the documents comprising the regular documents and the irregular document in the order of the page numbers.

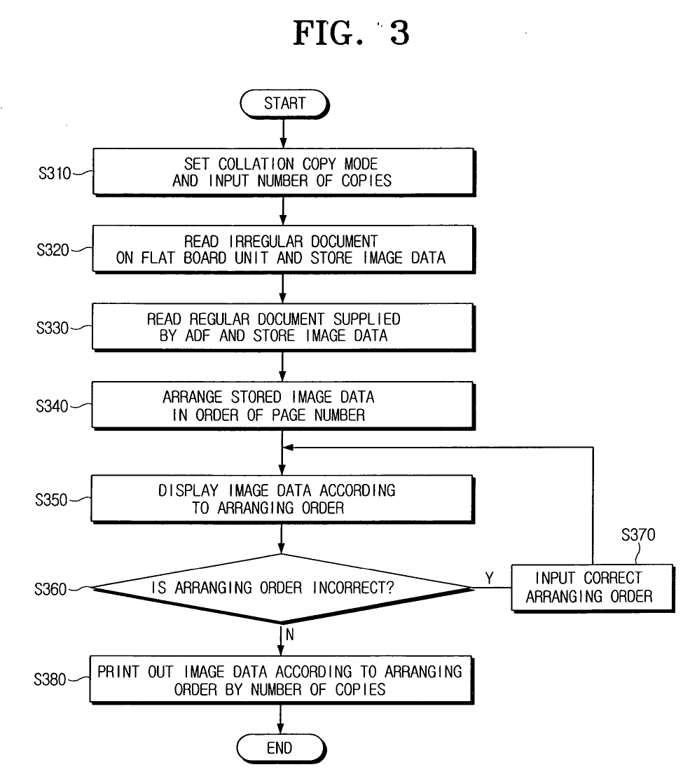

FIG. 3 is a flowchart illustrating a method of controlling an image forming apparatus according to an embodiment of the present general inventive concept.

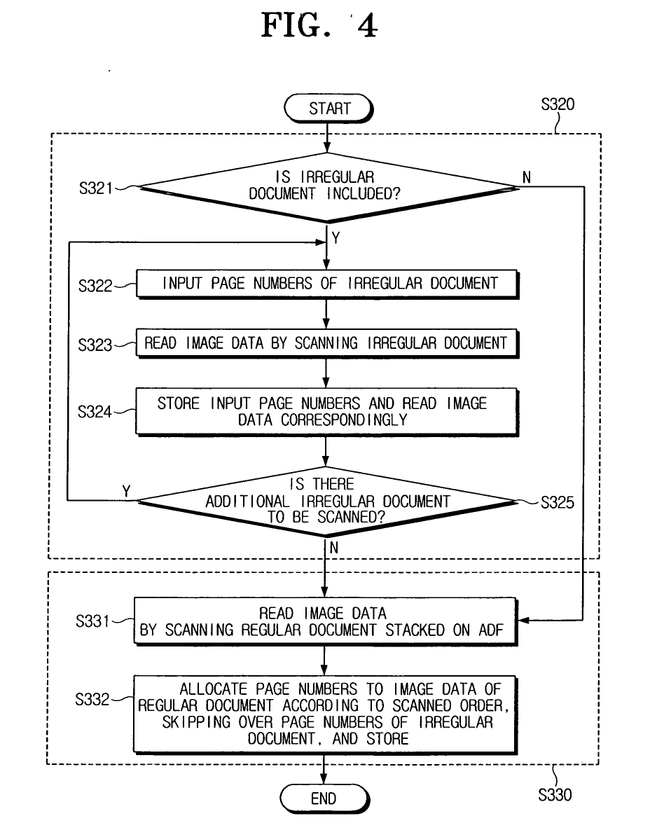

Referring to FIGS. 2 and 3, when the collation copy mode is selected through the input unit 240 (operation S310), the control unit 270 stores the image data of the irregular document, that is placed on the flat board unit 210 and read by the scan unit 220, in the storage unit 260 (operation S320). The image data obtained by scanning the regular document supplied by the ADF 230 is stored in the storage unit 260 (operation S330). The operations S320 to S330 are described in greater detail with reference to FIG. 4. A message inquiring whether the document to be copied includes at least one irregular document is displayed on the display unit 250 to be confirmed by the user (operation S321).

When it is confirmed that the document to be copied includes the irregular document, the control unit 270 displays on the display 250 a message prompting the user to input the page number of the irregular document (operation S322). When the document to be copied does not include the irregular document, the image data of the regular document stacked on the ADF 230 is read by the scan unit 220 (operation S331) and the collation copy mode is performed with the read image data.

When the user inputs the page number of the irregular document, the control unit 270 reads the image data of the irregular document placed on the flat board unit 210 with the scan unit 220 (operation S323), and stores in the storage unit 260 the input page number and the corresponding image data of the irregular document (operation S324).

The control unit 270 displays through the display unit 250 a message to check whether there is an additional irregular document to be scanned (operation S325). When there is the additional irregular document to be scanned, operations S322 to S324 are repeated until there is no additional irregular document to be scanned. According to the present embodiment, it can be checked every time when the scanned irregular document is stored, whether there is the additional irregular document to be scanned. However, when one or more page numbers of the irregular documents are input in the operation S321, the operations S322 to S324 may be repeated the input number of times corresponding to the one or more page numbers, the operation S325 can be omitted.

After the image data of all irregular documents is read, the control unit 270 controls the ADF 230 to consecutively supply the stacked regular document to the scan unit 220, to thereby read the image data of the regular document (operation S331).

Then, the control unit 270 allocates (assigns) page numbers, to the read image data of the regular documents in an order of scanning the image data. The image data of the regular document and the corresponding allocated page numbers are stored together in the storage unit 260 (operation S332).

Then, the control unit 270 arranges the stored image data of the irregular documents and the regular document, according to the order of the page numbers (operation S340).

The control unit 270 displays on the display unit 250 the image data according to the arranging order so that the user can check whether the arranging order of the image data is correct (operation S360). When there is an error in the order of the image data, the control unit 270 receives a new arranging order input by the user using the input unit 240 and corrects the order with a new arranging order so that pages of the image data can be renumbered or rearranged according to the new arranging order (operation S370).

Then, the control unit 270 transmits the image data stored in the storage unit 260 to the print unit 280 to print the image data in the arranging order a number of times corresponding to the set number of copies (operation S380).

According to an embodiment of the present general inventive concept, when copying a document comprising both pages of a regular size and pages of an irregular size, the collation copy can be performed without having to separately copy the irregular document which cannot be supplied to a scanner through an ADF, and insert the separately copied document one by one into the regular document.

In addition, according to an embodiment of the present general inventive concept, since the irregular document is not copied to be in the regular size and then recopied together with the rest regular document, deterioration of the image quality, caused by the recopying, can be prevented.

The general inventive concept can also be embodied as computer readable codes on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over a network coupled to the computer systems so that the computer readable code is stored and executed in a distributed fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling an image forming apparatus having an automatic document feeder (ADF) and a flat board unit, the method comprising:
reading at least one first document on the flat board unit;
reading a second document supplied by the ADF;
storing image data read from the at least one first document and the second document;
arranging the stored image data according to a predetermined order; and
printing the arranged image data according to the predetermined order.

2. The method of claim 1, further comprising:
displaying the image data according to the predetermined order; and
changing the predetermined order to generate a new order so that pages of the image data can be arranged according to the new order.

3. The method of claim 1, further comprising:
inputting the number of copies; and
printing the image data according to the predetermined order and the input number of copies.

4. The method of claim 1, wherein the at least one first document comprises at least one irregular document, the second document comprises a regular document, and the reading of the at least one first document on the flat board unit, comprises:
inputting a page number of the at least one irregular document; and
reading the image data by scanning the at least one irregular document input with the page number on the flat board unit.

5. The method of claim 4, further comprising:
checking whether there is an additional irregular document to be scanned;
inputting another page number for the additional irregular document; and
reading the image data of the additional irregular document.

6. The method of claim 4, further comprising:
inputting the number of times corresponding to the at least one irregular document; and
repeating the inputting of the page numbers of the irregular document and the reading of the image data of the irregular document according to the input number of times.

7. The method of claim 4, wherein the reading of the second document supplied from the ADF comprises:
reading the image data by scanning pages of the regular document supplied by the ADF; and
allocating second page numbers to the read image data of the respective pages of the regular document, without allocating the second page number to the at least one irregular document.

8. The method of claim 7, wherein the predetermined order is an order in which the respective image data of the regular and irregular documents are received.

9. The method of claim 7, wherein the storing of the image data of the at least one irregular document and the regular document comprises storing the image data of the read regular document and the at least one irregular document with the corresponding page numbers.

10. An image forming apparatus having an automatic document feeder (ADF) and a flat board unit, the image forming apparatus comprising:
a scan unit to read image data from a first document placed on the flat board unit and a second document supplied by the ADF;
a storage unit to store the image data read from the first and second documents;
a control unit to arrange the stored image data in a predetermined order; and
a print unit to print the arranged image data according to the predetermined order.

11. The image forming apparatus of claim 10, further comprising:
a display unit to display the stored image data arranged in the predetermined order; and
an input unit to input a new order so that the displayed image data is rearranged according to the new order.

12. The image forming apparatus of claim 11, wherein the scan unit scans the first document put on the flat board unit by moving in the conveyance direction of the document and scans the second document supplied from the ADF in a fixed state.

13. The image forming apparatus of claim 10, wherein the second document comprises a regular document supplied by the ADF, the first document comprises at least one irregular document placed on the flat board unit.

14. The image forming apparatus of claim 13, further comprising:
an input unit to input a first page number of the at least one irregular document and one or more second page numbers of one or more pages of the regular document,
wherein the control unit allocates the second page numbers to the one or more regular document in an order in which the one or more pages are scanned by the scan unit while allocating the first page number to the at least one irregular document.

15. The image forming apparatus of claim 13, wherein the storage unit stores the image data read by the scan unit with the corresponding first and second page numbers.

16. The image forming apparatus of claim 13, wherein:
the input unit inputs the number of copies; and
the control unit controls the print unit to print the image data in the predetermined order a number of times corresponding to the input number of copies.

17. A method of controlling an image forming apparatus, the method comprising:
inputting a second page number;
reading a second document to generate second data;
storing the second data of the read second document with the second page number;
inputting a first page number and a third page number;
reading a first document and a third document to generate first and third data;
storing the read first and third documents with the first and third page numbers, respectively; and
arranging the first data, the second data, and the third data according to the first, second, and third page numbers.

18. The method of claim 17, wherein the first and third documents have a first sized document, the second document has a second sized document different from the first sized document.

19. The method of claim 17, wherein the image forming apparatus comprises an ADF and a flat board unit, the reading of the second document comprise reading the second document which is stationary on the flat board unit, and the reading of the first and third documents comprises reading the first and third documents which are in a moving state by the ADF.

20. The method of claim 17, further comprising:
displaying the arranged first, second and third data.

21. The method of claim 17, further comprising:
printing the arranged first, second and third data.

22. An image forming apparatus comprising:
an input unit to input a first, a second, and a third page number;
a first reading unit to read a first and a third document to generate corresponding first and third data;
a second reading unit to read a second document to generate corresponding second data;
a storage unit to store the first, second and third data with the first, second and third page numbers; and
a control unit to arrange the first, the second and the third data according to the first the second and the third page numbers.

23. A computer readable storage medium to store computer readable codes to perform a method of controlling an image forming apparatus, the method comprising:
inputting a second page number;
reading a second document to generate second data;
storing the second data of the read second document with the second page number;
inputting a first page number and a third page number;
reading a first document and a third document to generate first and third data;
storing the read first and third documents with the first and third page numbers, respectively; and
arranging the first data, the second data, and the third data according to the first, second, and third page numbers.
